(19) United States
(12) Patent Application Publication
(10) Pub. No.: US 2025/0374889 A1
(43) Pub. Date: Dec. 11, 2025

(54) PET NAIL GRINDER

(71) Applicant: Qiong Chen, Shenzhen City (CN)

(72) Inventor: Qiong Chen, Shenzhen City (CN)

(21) Appl. No.: 18/734,713

(22) Filed: Jun. 5, 2024

(51) Int. Cl. A01K 13/00; A45D 29/05

(52) U.S. Cl. CPC A01K 13/00; A45D 29/05

(57) ABSTRACT

The present invention discloses a pet nail grinder, which comprises: a housing, a driving mechanism, and a grinding assembly, wherein the grinding assembly comprises a grinding head and an elastic limiting member, the grinding head comprises a grinding wheel and a fixed rod fixedly connected to the grinding wheel, the fixed rod extends into the mounting cavity from the mounting hole and is inserted into the mounting groove, the elastic limiting member is provided with a limiting portion, the elastic limiting member comprises a fixing portion and a limiting portion fixedly connected to the fixing portion, the fixing portion of the elastic limiting member is sleeved on an outer wall of the mounting base, and the limiting portion of the elastic limiting member extends into the mounting groove from the first limiting groove and abuts against the fixed rod.

### TECHNICAL FIELD

The present invention relates to the technical field of pet products, and in particular, to a pet nail grinder.

### BACKGROUND

With the improvement of living standards of people, people are pursuing spiritual trust when their material needs are met. Therefore, in order to eliminate loneliness or seek entertainment, people began to raise animals to accompany them. Among all animal pets, dogs and cats are the most popular. Dogs and cats may have nails like humans. The sharp nails may easily scratch owners or damage furniture, and if nails are not trimmed in time, the nails may bend and grow into the paw pads of pets, causing discomfort, inconvenience in movement, and even inflammation and necrosis. Therefore, owners need to trim pet nails regularly.

In the prior art, a grinding head of a common electric pet nail grinder is directly connected to a motor, or directly inserted into a mounting base connected to the motor. During the grinding process, due to the high hardness of pet nails, the grinding head is easily subjected to excessive force and separated from the main body of the nail grinder, resulting in safety accidents.

### SUMMARY

A primary objective of the present invention is to provide a pet nail grinder, which aims to solve low safety of nail grinders in the prior art.

In order to achieve the above objective, the present invention provides a pet nail grinder. The pet nail grinder comprises:
a housing, wherein the housing is provided with a mounting cavity and a mounting hole communicated with the mounting cavity;
a driving mechanism, wherein the driving mechanism is arranged in the mounting cavity and comprises a driving motor and a mounting base fixedly connected to the driving motor, a top of the mounting base is provided with a mounting groove, and a side wall of the mounting base is provided with a first limiting groove communicated with the mounting groove; and
a grinding assembly, wherein the grinding assembly comprises a grinding head and an elastic limiting member, the grinding head comprises a grinding wheel and a fixed rod fixedly connected to the grinding wheel, the fixed rod extends into the mounting cavity from the mounting hole and is inserted into the mounting groove, the elastic limiting member comprises a fixing portion and a limiting portion fixedly connected to the fixing portion, the fixing portion of the elastic limiting member is sleeved on an outer wall of the mounting base, and the limiting portion of the elastic limiting member extends into the mounting groove from the first limiting groove and abuts against the fixed rod.

Optionally, a side wall of the fixed rod is provided with a second limiting groove, and a limiting portion of the elastic limiting member is positioned in the second limiting groove.

Optionally, the outer wall of the mounting base is provided with an annular groove communicated with the first limiting groove, and the fixing portion is positioned in the annular groove.

Optionally, the fixing portion is annular, and the limiting portion is perpendicular to the fixing portion.

Optionally, the fixing portion is arc-shaped, two ends of the fixing portion are vertically connected to the limiting portion, and the mounting base is provided with two first limiting grooves corresponding to the limiting portion of the elastic limiting member.

Optionally, the fixed rod is polygonal prism-shaped, and a shape of the mounting groove is adapted to that of the fixed rod.

Optionally, an inner wall of the mounting groove is provided with a plurality of abutment blocks, and the plurality of abutment blocks are arranged at intervals on the inner wall of the mounting groove.

Optionally, the driving mechanism further comprises a control assembly electrically connected to the driving motor, the control assembly is arranged in the mounting cavity, and the control assembly is configured to control a rotation speed of the driving motor.

Optionally, the control assembly comprises a main control board and a speed regulator electrically connected to the main control board.

Optionally, the speed regulator comprises a code control board and a roller connected to the code control board, an outer wall of the housing is provided with a clearance hole, and the roller extends out of the housing from the clearance hole.

Optionally, the main control board is provided with a digital display screen, and a hollow portion is formed at a position of the housing corresponding to the digital display screen.

Optionally, the pet nail grinder further comprises a transparent plate, and the transparent plate is attached to an outer wall of the housing and shields the hollow portion of the housing.

Optionally, the pet nail grinder further comprises a key connected to the main control board.

Optionally, the pet nail grinder further comprises a protective cover, the protective cover is arranged on the grinding head, and the protective cover is provided with at least one grinding hole.

Optionally, the housing is provided with a fixing boss, and the protective cover is fixed on the fixing boss.

Optionally, the pet nail grinder further comprises a protection cover, and the protection cover is arranged on the grinding head and detachably connected to the housing.

Optionally, the pet nail grinder further comprises a battery pack electrically connected to the driving motor.

Optionally, the outer wall of the housing is provided with an anti-slip plate.

According to the technical solution of the present invention, the housing is configured to provide a mounting position for other structures of the nail grinder and protect the other structures from being damaged by external force, the driving mechanism is arranged in the housing and configured to provide power for the grinding head, the driving mechanism comprises a driving motor and a mounting base, a top of the mounting base is provided with a mounting groove, one end of the grinding head extends into the housing from a mounting hole and is fixed in the mounting groove; in addition, a side wall of the mounting base is provided with a first limiting groove communicated with the mounting groove, the elastic limiting member is provided with a limiting portion, the elastic limiting member is sleeved on the outer wall of the mounting base, and the limiting portion of the elastic limiting member extends into the mounting groove from the first limiting groove and abuts against the fixed rod, so that the grinding head is effectively prevented from being separated from the mounting base in the rotating process, and therefore the safety of the pet nail grinder is effectively improved.

### BRIEF DESCRIPTION OF DRAWINGS

In order to more clearly illustrate the technical solutions in the embodiments of the present invention or in the prior art, the drawings required to be used in the description of the embodiments or the prior art are briefly introduced below. It is obvious that the drawings in the description below are some embodiments of the present invention, and those of ordinary skill in the art can obtain other drawings according to the structures illustrated in these drawings without creative efforts.

FIG. 1 is a schematic diagram of an overall structure of an embodiment of a pet nail grinder according to the present invention;

FIG. 2 is a schematic diagram of an exploded structure of an embodiment of a pet nail grinder according to the present invention;

FIG. 3 is a schematic diagram of an exploded structure of another embodiment of a pet nail grinder according to the present invention;

FIG. 4 is a schematic diagram of a structure of a protective cover from one angle;

FIG. 5 is a schematic diagram of a structure of a protective cover from another angle;

FIG. 6 is a schematic diagram of a structure of an embodiment of an elastic limiting member;

FIG. 7 is a schematic diagram of a structure of another embodiment of an elastic limiting member;

FIG. 8 is a schematic diagram of a structure of a mounting base; and

FIG. 9 is a schematic diagram of a structure of a grinding head.

### DESCRIPTIONS OF REFERENCE NUMERALS

| Reference | | Reference | |
|---|---|---|---|
| numeral | Name | numeral | Name |
| 10 | Housing | 41 | Driving motor |
| 11 | Mounting cavity | 42 | Main control board |
| 12 | Mounting hole | 421 | Digital display |
| | | | screen |
| 13 | Clearance hole | 431 | Code control board |
| 14 | Fixing boss | 432 | Roller |
| 15 | Hollow portion | 50 | Grinding head |
| 141 | Sliding groove | 51 | Grinding wheel |
| 20 | Mounting base | 52 | Fixed rod |
| 21 | Mounting groove | 521 | Second limiting |
| | | | groove |
| 22 | Abutment block | 60 | Key |
| 23 | First limiting groove | 70 | Protective cover |
| 24 | Annular groove | 71 | Grinding hole |
| 30 | Elastic limiting | 72 | Sliding block |
| | member | | |
| 31 | Fixing portion | 80 | Protection cover |
| 32 | Limiting portion | 90 | Battery pack |
| 100 | Anti-slip plate | 110 | Transparent plate |

The realization of the objectives, the functional features, and the advantages of the present invention will be further explained in conjunction with the embodiments and with reference to the drawings.

### DETAILED DESCRIPTION OF EMBODIMENTS

The following clearly and completely describes the technical solutions in the embodiments of the present invention with reference to drawings in the embodiments of the present invention. It is clear that the described embodiments are merely a part rather than all of the embodiments of the present invention. All other embodiments obtained by those of ordinary skill in the art based on embodiments of the present invention without creative efforts shall fall within the protection scope of the present invention.

It should be noted that, if directional indications (such as upper, lower, left, right, front and rear) are involved in the embodiments of the present invention, the directional indications are only used to explain the relative positional relationships, the motion situations and the like between individual components under a certain pose (as shown in the drawings), and if the certain pose is changed, the directional indications are changed accordingly.

In addition, if there are descriptions relating to “first”, “second” and the like in the embodiments of the present invention, the descriptions of “first”, “second” and the like are for descriptive purposes only and are not to be construed as indicating or implying relative importance thereof or implicitly indicating the quantities of the indicated technical features. Thus, a feature defined by “first” or “second” may explicitly or implicitly include at least one such feature. In addition, “and/or” appearing herein is meant to include three parallel solutions, and taking “A and/or B” as an example, it includes solution A, or solution B, or both solution A and solution B. In addition, the technical solutions among various embodiments may be combined with each other, however, this combination must be based on that it can be realized by those of ordinary skill in the art. When the combination of the technical solutions is contradictory or cannot be realized, such a combination of the technical solutions should not be considered to exist, and is not within the protection scope of the present invention.

The present invention provides a pet nail grinder.

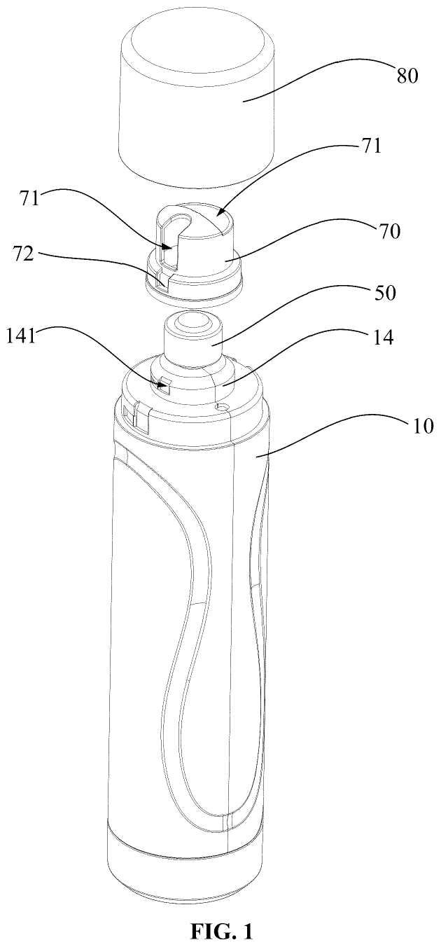

In an embodiment of the present invention, as shown in FIGS. 1 to 3, the pet nail grinder comprises: a housing 10, wherein the housing 10 has a mounting cavity, and the housing 10 is provided with a mounting hole 12 communicated with the mounting cavity 11;
a driving mechanism, wherein the driving mechanism is arranged in the mounting cavity 11 and comprises a driving motor 41 and a mounting base 20 fixedly connected to the driving motor 41, a top of the mounting base 20 is provided with a mounting groove 21, and a side wall of the mounting base 20 is provided with a first limiting groove 23 communicated with the mounting groove 21; and
a grinding assembly, wherein the grinding assembly comprises a grinding head 50 and an elastic limiting member 30, the grinding head 50 comprises a grinding wheel 51 and a fixed rod 52 fixedly connected to the grinding wheel 51, the fixed rod 52 extends into the mounting cavity 11 from the mounting hole 12 and is inserted into the mounting groove 21, the elastic limiting member 30 comprises a fixing portion 31 and a limiting portion 32 fixedly connected to the fixing portion 31, the fixing portion 31 of the elastic limiting member 30 is sleeved on an outer wall of the mounting base 20, and the limiting portion 32 of the elastic limiting member 30 extends into the mounting groove 21 from the first limiting groove 23 and abuts against the fixed rod 52.

In this embodiment, the housing 10 is configured to provide a mounting position for other structures of the nail grinder and protect the other structures from external force, the housing 10 is provided with a mounting cavity 11, the mounting cavity 11 is configured to mount other components of the nail grinder, the top of the housing 10 is provided with a mounting hole 12 communicated with the mounting cavity 11, and the mounting hole 12 is configured to allow the grinding head 50 to extend into the mounting cavity 11 to be connected to the driving motor 41; the driving structure is arranged in the housing 10 and configured to provide rotary power for the grinding head 50; and the grinding head 50 is configured to grind the pet nails. Specifically, the grinding head 50 is rotated by the driving motor 41, and rubs against the pet nails during the rotation, thereby shortening and polishing the pet nails through friction.

The mounting base 20 is configured to fix the grinding head 50. Specifically, the mounting base 20 is cylindrical, one end of the mounting base is fixed on the driving motor 41, the other end of the mounting base is provided with a mounting groove 21, and the grinding head 50 is mounted in the mounting groove 21 through the mounting hole 12, so that the grinding head 50, the mounting base 20 and the driving motor 41 are relatively fixed, and the stability of the driving motor 41 for driving the grinding head 50 to rotate is further improved.

The grinding head 50 comprises a grinding wheel 51 and a fixed rod 52 fixedly connected to the grinding wheel 51, the grinding wheel 51 is configured to trim the pet nails by friction, and the fixed rod 52 is inserted into the mounting groove 21 to transmit the power provided by the driving motor 41, so as to drive the grinding wheel 51 to rotate. The fixed rod 52 may be cylindrical or polygonal. When the fixed rod 52 is cylindrical, the relative friction between the fixed rod 52 and the inner wall of the mounting groove 21 is small, so that the fixed rod 52 slides relative to the inner wall of the mounting groove 21 in the rotation process, thereby affecting the grinding efficiency of the grinding head 50; and when the fixed rod 52 is polygonal, the shape of the mounting groove 21 is adapted to that of the fixed rod 52, so that the fixed rod 52 can be effectively prevented from sliding relative to the inner wall of the mounting groove 21, the fixed rod 52 and the mounting base 20 can always keep synchronous rotation, and the grinding efficiency of the nail grinder is effectively improved.

The elastic limiting member 30 is configured to limit the grinding head 50 to be separated from the mounting base 20. Specifically, the elastic limiting member 30 is arranged on the outer wall of the mounting base 20, the outer wall of the mounting base 20 is provided with a first limiting groove 23 communicated with the mounting groove 21, the elastic limiting member 30 is sleeved on the outer wall of the mounting base 20, a limiting portion 32 of the elastic limiting member 30 extends into the mounting groove 21 from the first limiting groove 23 and abuts against the fixed rod 52; therefore the friction force of the fixed rod 52 in a vertical direction is improved, the grinding head 50 can be effectively prevented from being separated from the mounting base 20, and the structural stability of the nail grinder is improved.

According to the technical solution of the present invention, the housing 10 is configured to provide a mounting position for other structures of the nail grinder and protect the other structures from being damaged by external force, the driving mechanism is arranged in the housing and configured to provide power for the grinding head 50, the driving mechanism comprises a driving motor 41 and a mounting base 20, a top of the mounting base 20 is provided with a mounting groove 21, one end of the grinding head 50 extends into the housing 10 from a mounting hole 12 and is fixed in the mounting groove 21; in addition, a side wall of the mounting base 20 is provided with a first limiting groove 23 communicated with the mounting groove 21, the elastic limiting member 30 is provided with a limiting portion 32, the elastic limiting member 30 is sleeved on the outer wall of the mounting base 20, and the limiting portion 32 of the elastic limiting member 30 extends into the mounting groove 21 from the first limiting groove 23 and abuts against the fixed rod 52, so that the grinding head 50 is effectively prevented from being separated from the mounting base in the rotating process, and therefore the safety of the pet nail grinder is effectively improved.

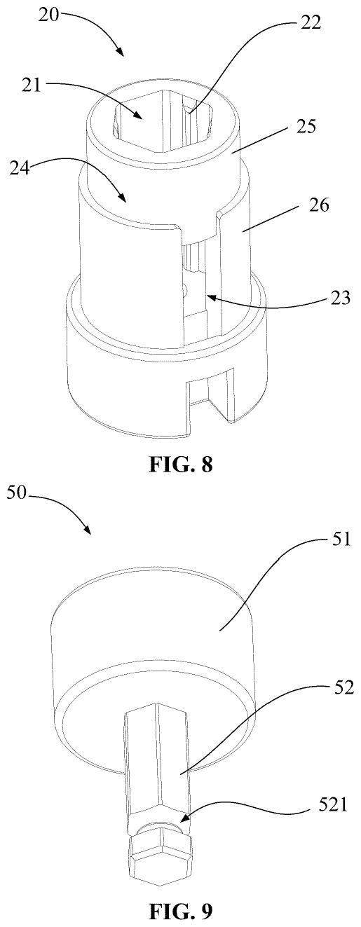

Further, as shown in FIG. 9, a side wall of the fixed rod 52 is provided with a second limiting groove 521, and the limiting portion 32 of the elastic limiting member 30 is positioned in the second limiting groove 521. In this embodiment, the second limiting groove 521 is configured to cooperate with the elastic limiting member 30 to prevent the grinding head 50 from being separated from the mounting base 20. Specifically, the side wall of the fixed rod 52 is provided with the second limiting groove 521, and the limiting portion 32 of the elastic limiting member 30 is positioned in the second limiting groove 521, so that when the grinding head 50 is rotated, the grinding head 50 and the mounting base 20 are always relatively fixed, and the movement of the grinding head 50 in an axial direction of the mounting base 20 is limited, thereby effectively improving the structural stability of the nail grinder.

It should be explained that a vertical cross section of the second limiting groove 521 is similar to a V shape, and different grinding heads 50 are required for the nails of different pets, so that the grinding head 50 is detachably connected to the mounting base 20. When a user needs to replace the grinding head 50, the user only pulls the grinding head 50, so that the elastic limiting member 30 can be pulled out of the second limiting groove 521, thereby facilitating the user to replace the grinding head 50.

Further, as shown in FIG. 8, the outer wall of the mounting base 20 is provided with an annular groove 24 communicated with the first limiting groove 23, the elastic limiting member 30 comprises a fixing portion 31 and a limiting portion 32 fixedly connected to the fixing portion 31, and the fixing portion 31 is positioned in the annular groove 24, so that the elastic limiting member 30 is effectively restricted from moving in an vertical direction of the mounting base 20, and therefore, the structural stability of the nail grinder is effectively improved.

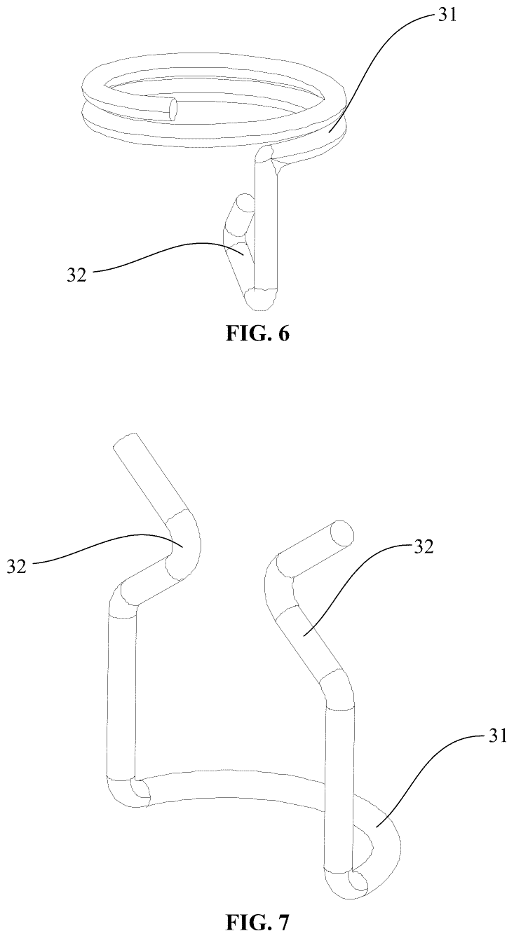

Further, as shown in FIG. 6, the fixing portion 31 of the elastic limiting member 30 is annular and is sleeved in the annular groove 24 of the mounting base 20, the limiting portion 31 is vertically connected to a boundary of the fixing portion 31, and the limiting portion 31 partially protrudes toward a center of the fixing portion 31.

Further, as shown in FIG. 7, the fixing portion is arc-shaped, two ends of the fixing portion are vertically connected to the limiting portion, and the mounting base is provided with two first limiting grooves corresponding to the limiting portion of the elastic limiting member.

Further, as shown in FIG. 8, an inner wall of the mounting groove 21 is provided with a plurality of abutment blocks 22, and the plurality of abutment blocks 22 are arranged at intervals on the inner wall of the mounting groove 21. In this embodiment, the abutment block 22 is used to improve the stability of the grinding head 50 mounted on the mounting base 20. Specifically, a plurality of abutting blocks 22 are arranged on the inner wall of the mounting groove 21, when the fixed rod 52 is inserted into the mounting groove 21, the abutting block 22 compresses the outer wall of the fixed rod 52, so as to improve the friction force between the fixed rod 52 and the mounting groove 21, effectively prevent the fixed rod 52 from moving up and down in the mounting groove 21 to affect the grinding stability of the nail grinder; therefore, the grinding efficiency of the nail grinder is effectively improved.

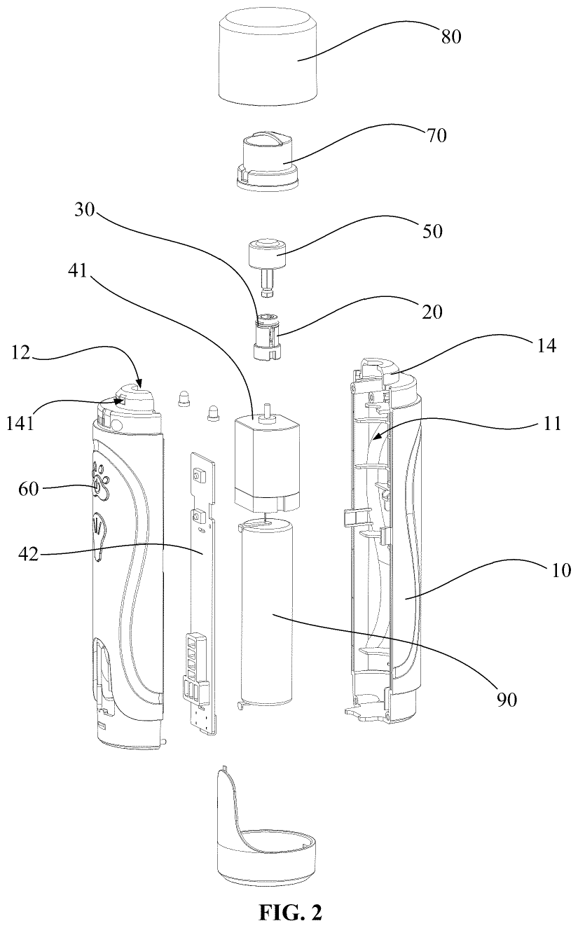

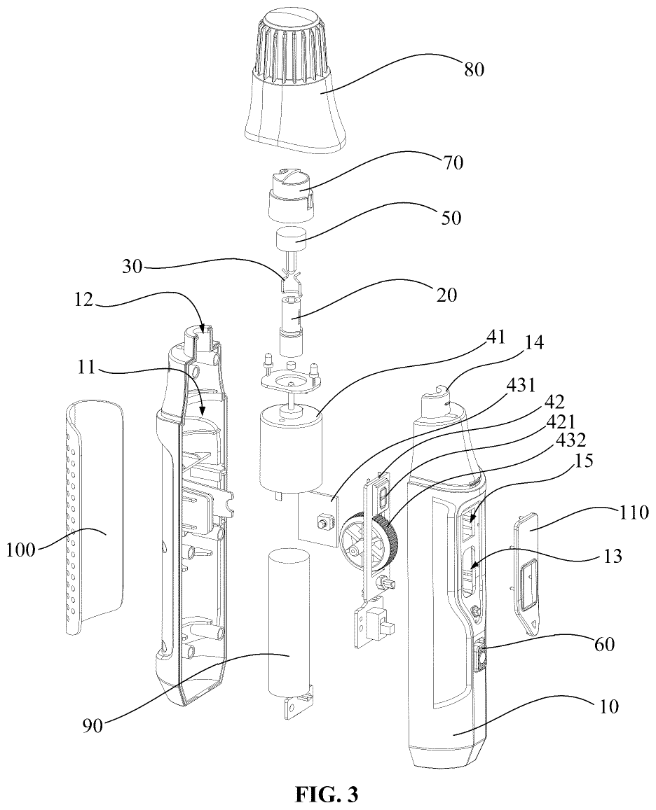

Further, as shown in FIG. 2 and FIG. 3, the driving mechanism further comprises a control assembly electrically connected to the driving motor 41, the control assembly is arranged in the mounting cavity 11, and the control assembly is configured to control a rotation speed of the driving motor 41. In this embodiment, since the strength and size of the pet nails are different, the rotation speed of the grinding head 50 is adjusted based on different requirements of the pet nails in the daily pet nail trimming process. In this embodiment, a control assembly is arranged in the nail grinder to control the rotation speed of the driving motor 41, thereby making the nail grinder suitable for trimming more different types of pet nails, so that the practicality of the nail grinder is effectively improved.

Further, as shown in FIG. 3, the control assembly comprises a main control board 42 and a speed regulator electrically connected to the main control board 42. In this embodiment, the main control board 42 is configured to signal conversion, the speed regulator is a physical structure for the user to control the rotation speed of the driving motor 41. Specifically, the user operates the speed regulator, the speed regulator generates an electrical signal and sends the electrical signal to the main control board 42, and the main control board 42 converts the electrical signal into a control command and sends the control command to the driving motor 41, so as to control the speed of the driving motor 41.

Further, the speed regulator comprises a code control board 431 and a roller 432 connected to the code control board 431, an outer wall of the housing 10 is provided with a clearance hole 13, and the roller 432 extends out of the housing 10 from the clearance hole 13 to facilitate user operation.

Further, as shown in FIG. 3, the main control board 42 is provided with a digital display screen 421, and a hollow portion 15 is formed at a position of the housing 10 corresponding to the digital display screen 421. In this embodiment, the digital display screen 421 is configured for the user to observe the state of charge or the rotation speed of the nail grinder. Specifically, the digital display screen 421 is arranged on the main control board 42 and is arranged near the inner wall of the housing 10, and a hollow portion 15 is formed at a position of the housing 10 corresponding to the digital display screen 421 for the user to observe. The digital display screen 421 may be an LED lamp bead display screen, or a liquid crystal display screen, which is not limited herein.

Further, the pet nail grinder further comprises a transparent plate 110, and the transparent plate 110 is attached to the outer wall of the housing 10 and shields the hollow portion 15 of the housing 10, so that the digital display screen 421 is effectively prevented from being damaged by external force, and the practicability of the pet nail grinder is effectively improved.

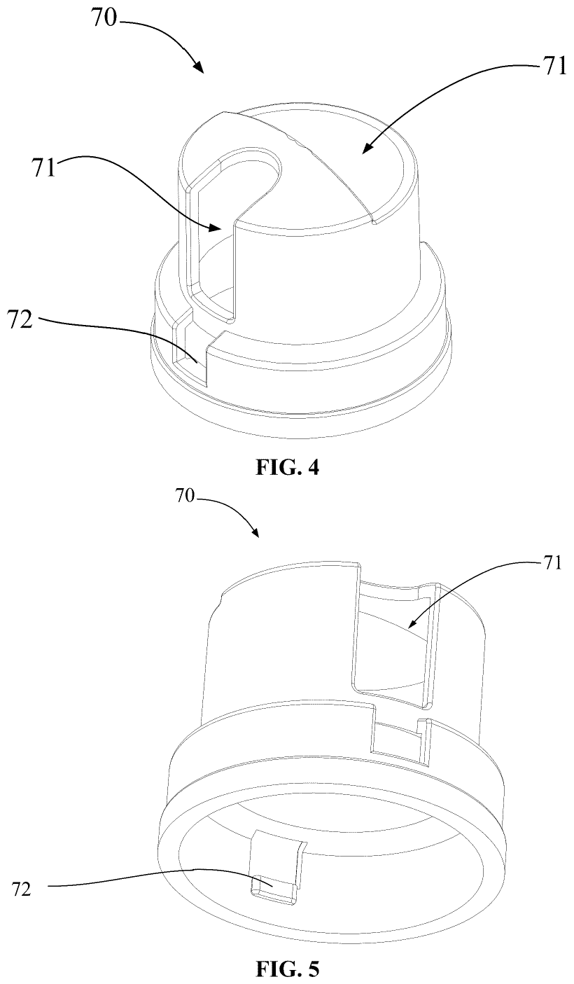

Further, as shown in FIGS. 1 to 4, the pet nail grinder further comprises a key 60 connected to the main control board 42. In this embodiment, the key 60 is configured for the user to select the operation mode of the nail grinder, wherein the outer wall of the housing 10 is provided with a mounting through hole, and the key 60 is arranged in the mounting through hole.

Further, as shown in FIGS. 1 to 3 and 4, the pet nail grinder further comprises a protective cover 70, the protective cover 70 is arranged on the grinding head 50, and the protective cover 70 is provided with at least one grinding hole 71. In this embodiment, the protective cover 70 is used to prevent the pet nails from splashing when the nail grinder is used to trim the pet nails; wherein the protective cover 70 is provided with at least one grinding hole 71, and the grinding hole 71 is used for the user to extend the pet nails into the protective cover 70 from the grinding hole 71 to rub against the grinding head 50.

Further, as shown in FIGS. 1 to 3 and 4, the housing 10 is provided with a fixing boss 14, and the protective cover 70 is fixed on the fixing boss 14. In this embodiment, the fixing boss 14 is configured to fix the protective cover 70. Specifically, the fixing boss 14 is protruded from the outer wall of the housing 10, the mounting hole 12 is arranged at the top of the fixing boss 14, and the protective cover 70 is detachably connected to the fixing boss 14. The protective cover 70 may be connected to the fixing boss 14 by a buckle or a sliding groove 141, preferably, the protective cover 70 is connected to the fixing boss 14 by the sliding groove 141. Specifically, the sliding groove 141 is arranged on the outer wall of the fixing boss 14, and the sliding block 72 is arranged on the inner wall of the protective cover 70.

Further, as shown in FIGS. 1 to 3, the pet nail grinder further comprises a protection cover 80, wherein the protection cover 80 covers the grinding head 50 and is detachably connected to the housing 10, thereby effectively preventing the protective cover 70 or the grinding head 50 from being damaged by external force.

Further, as shown in FIGS. 1 to 3, the pet nail grinder further comprises a battery pack 90 electrically connected to the driving motor 41. In this embodiment, the nail grinder may be directly connected to a power supply to supply power to the driving motor 41, or a battery pack 90 may be provided in the housing 10 to supply power to the driving motor 41, and preferably, the battery pack 90 is provided in the housing 10 to supply power to the driving motor 41, thereby improving portability of the nail grinder.

Further, as shown in FIG. 3, the outer wall of the housing 10 is provided with an anti-slip plate 100. In this embodiment, the anti-slip plate 100 is arranged on the outer wall of the housing 10, so as to effectively prevent the housing 10 from slipping during use to affect the use experience of the user, thereby effectively improving the practicability of the nail grinder.

The above mentioned contents are only optional embodiments of the present invention and are not intended to limit the patent scope of the present invention, and under the inventive concept of the present invention, the equivalent structural transformations made by using the contents of the specification and the drawings of the present invention, or direct/indirect applications to other related technical fields, are all included in the patent protection scope of the present invention.

What is claimed is:

1. A pet nail grinder, comprising:
a housing, wherein the housing is provided with a mounting cavity and a mounting hole communicated with the mounting cavity;
a driving mechanism, wherein the driving mechanism is arranged in the mounting cavity and comprises a driving motor and a mounting base fixedly connected to the driving motor, a top of the mounting base is provided with a mounting groove; and
a grinding assembly, wherein the grinding assembly comprises a grinding head and an elastic limiting member, the grinding head comprises a grinding wheel and a fixed rod fixedly connected to the grinding wheel, the fixed rod extends into the mounting cavity from the mounting hole and is inserted into the mounting groove, the elastic limiting member comprises a fixing portion and a limiting portion fixedly connected to the fixing portion;
wherein the mounting base comprises a first segment and a second segment, an outer diameter of the second segment is larger than an outer diameter of the first segment; a side wall of the second segment of the mounting base is provided with a first limiting groove communicated with the mounting groove, and an outer wall of the first segment of the mounting base is provided with an annular groove communicated with the first limiting groove; the fixing portion is positioned in the annular groove and the limiting portion extends into the mounting groove from the first limiting groove and abuts against the fixed rod.

2. The pet nail grinder according to claim 1, wherein a side wall of the fixed rod is provided with a second limiting groove, and a limiting portion of the elastic limiting member is positioned in the second limiting groove.

3. (canceled)

4. The pet nail grinder according to claim 1, wherein the fixing portion is annular, and the limiting portion is perpendicular to the fixing portion.

5. The pet nail grinder according to claim 1, wherein the fixing portion is arc-shaped, two ends of the fixing portion are vertically connected to the limiting portion, and the mounting base is provided with two first limiting grooves corresponding to the limiting portion of the elastic limiting member.

6. The pet nail grinder according to claim 1, wherein the fixed rod is polygonal prism-shaped, and a shape of the mounting groove is adapted to that of the fixed rod.

7. The pet nail grinder according to claim 6, wherein an inner wall of mounting groove is provided with a plurality of abutment blocks, and the plurality of abutment blocks are arranged at intervals on the inner wall of the mounting groove.

8. The pet nail grinder according to claim 1, wherein the driving mechanism further comprises a control assembly electrically connected to the driving motor, the control assembly is arranged in the mounting cavity, and the control assembly is configured to control a rotation speed of the driving motor.

9. The pet nail grinder according to claim 8, wherein the control assembly comprises a main control board and a speed regulator electrically connected to the main control board.

10. The pet nail grinder according to claim 9, wherein the speed regulator comprises a code control board and a roller connected to the code control board, an outer wall of the housing is provided with a clearance hole, and the roller extends out of the housing from the clearance hole.

11. The pet nail grinder according to claim 9, wherein the main control board is provided with a digital display screen, and a hollow portion is formed at a position of the housing corresponding to the digital display screen.

12. The pet nail grinder according to claim 11, wherein the pet nail grinder further comprises a transparent plate, and the transparent plate is attached to an outer wall of the housing and shields the hollow portion of the housing.

13. The pet nail grinder according to claim 9, wherein the pet nail grinder further comprises a key connected to the main control board.

14. The pet nail grinder according to claim 1, wherein the pet nail grinder further comprises a protective cover, the protective cover is arranged on the grinding head, and the protective cover is provided with at least one grinding hole.

15. The pet nail grinder according to claim 14, wherein the housing is provided with a fixing boss, and the protective cover is fixed on the fixing boss.

16. The pet nail grinder according to claim 1, wherein the pet nail grinder further comprises a protection cover, and the protection cover is arranged on the grinding head and detachably connected to the housing.

17. The pet nail grinder according to claim 1, wherein the pet nail grinder further comprises a battery pack electrically connected to the driving motor.

18. The pet nail grinder according to claim 1, wherein the outer wall of the housing is provided with an anti-slip plate.
